(19) United States
(12) Patent Application Publication
(10) Pub. No.: US 2024/0047099 A1
(43) Pub. Date: Feb. 8, 2024

(54) WIRING HARNESS

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventors: Yutaka TAKATA, Mie (JP); Mikiya FURUKAWA, Mie (JP)

(21) Appl. No.: 18/265,402

(22) PCT Filed: Dec. 9, 2021
(86) PCT No.: PCT/JP2021/045335

§ 371 Date: Jun. 5, 2023

(30) Foreign Application Priority Data
Dec. 24, 2020 (JP) 2020-215820

(51) Int. Cl. H01B 7/282; H01B 7/00; H02G 15/18; C09D 135/02; C09D 133/24; C09D 133/26; C09D 139/04; C09D 133/14; C09D 133/08

(52) U.S. Cl. CPC H01B 7/2825; H01B 7/0045; H02G 15/1806; C09D 135/02; C09D 133/24; C09D 133/26; C09D 139/04; C09D 133/14; C09D 133/08; C08L 2203/202; C08L 2203/206

(57) ABSTRACT

It is aimed to provide a wiring harness, in which a part where a wire conductor is exposed from an insulation coating is covered by a waterproof portion and which can maintain the adhesiveness of the waterproof portion to the insulation coating containing a plasticizer even if being placed in a high-temperature and high-humidity environment. A wiring harness is provided with a wire including a conductor, an insulation coating covering an outer periphery of the conductor and a conductor exposed portion, in which the conductor is exposed from the insulation coating, and a waterproof portion for integrally covering surfaces of the conductor exposed portion and the insulation coating. The insulation coating contains a plasticizer. The waterproof portion is constituted as a cured body of a resin composition containing a urethane (meth)acrylate oligomer and a nitrogen-containing monomer, which is a radical polymerizable monomer containing a nitrogen atom.

### TECHNICAL FIELD

The present disclosure relates to a wiring harness.

### BACKGROUND

In a wiring harness including a plurality of wires, conductors exposed from insulation coatings of the respective wires may be joined to each other using a crimping terminal or the like to form a splice portion. A wiring harness provided with such a splice portion is disclosed in Patent Document 1 to 3 and the like. For the purpose of protecting the splice portion from contact with water, a part including the splice portion may be covered with a resin material impermeable to water. Particularly, if the wiring harness is used in an environment in which the wiring harness easily contacts water such as by being installed in an automotive vehicle, it is important to waterproof the splice portion. In each of Patent Document 1 to 3, a constituent material of a waterproof part is studied to obtain desired characteristics such as high waterproof performance

### PRIOR ART DOCUMENT

### Patent Document

Patent Document 1: JP 2015-159070 A
Patent Document 2: WO 2014/112157 A1
Patent Document 3: JP 2016-091629 A
Patent Document 4: JP 2019-085394 A
Patent Document 5: JP 2015-182912 A

### SUMMARY OF THE INVENTION

### Problems to be Solved

As also described in Patent Document 1 to 3, urethane (meth)acrylate is often used to form a waterproof portion at a location where a wire conductor is exposed from an insulation coating such as a splice portion in a wiring harness. Urethane (meth)acrylate is an excellent material which can provide high waterproof performance while ensuring flexibility. However, in placing the wiring harness in a high-temperature and high-humidity environment, the waterproof performance exhibited by urethane (meth)acrylate is possibly affected. For example, an insulation coating constituting a wiring harness are often made of polyvinyl chloride (PVC) containing a plasticizer. If the insulation coating is placed in a high-temperature and high-humidity environment with a waterproof portion held in contact with the insulation coating, the plasticizer possibly migrates from the insulation coating to the waterproof portion. Due to the migration of the plasticizer, the adhesiveness of the waterproof portion to the insulation coating is reduced, possibly leading to a reduction in waterproof performance. In Patent Document 2, the migration of a plasticizer is suppressed by setting a solubility parameter of a curable material constituting a waterproof portion to a predetermined value or more. However, there is a room for further study for a constituent material of the waterproof portion from the perspective of effectively suppressing a reduction in adhesiveness due to the migration of the plasticizer, particularly in a high-temperature and high-humidity environment.

Accordingly, it is aimed to provide a wiring harness, in which a wire conductor is covered by a waterproof portion at a location exposed from an insulation coating and which can maintain the adhesiveness of the waterproof portion to the insulation coating containing a plasticizer even if the wiring harness is placed under a high-temperature and high-humidity environment.

### Means to Solve the Problem

The present disclosure is directed to a wiring harness with a wire including a conductor, an insulation coating covering an outer periphery of the conductor and a conductor exposed portion, the conductor being exposed from the insulation coating in the conductor exposed portion, and a waterproof portion for integrally covering surfaces of the conductor exposed portion and the insulation coating, the insulation coating containing a plasticizer, and the waterproof portion being constituted as a cured body of a resin composition containing a urethane (meth)acrylate oligomer and a nitrogen-containing monomer, the nitrogen-containing monomer being a radical polymerizable monomer containing a nitrogen atom.

### Effect of the Invention

The wiring harness of the present disclosure is a wiring harness, in which the wire conductor is covered by the waterproof portion at a location exposed from the insulation coating and which can maintain the adhesiveness of the waterproof portion to the insulation coating containing the plasticizer even if the wiring harness is placed under a high-temperature and high-humidity environment.

### BRIEF DESCRIPTION OF THE DRAWINGS

FIG. 1 is a side view showing a wiring harness according to one embodiment of the present disclosure.

FIG. 2 is a graph showing a change of adhesive strength over time under a high-temperature and high-humidity environment for a case where a nitrogen-containing monomer (ACMO) is added to a resin composition and a case where the nitrogen-containing monomer (ACMO) is not added.

FIG. 3 is a graph showing infrared absorption spectra before and after leaving to stand in the high-temperature and high-humidity environment for the case where the nitrogen-containing monomer (ACMO) is added to the resin composition and the case where the nitrogen-containing monomer (ACMO) is not added.

FIGS. 4A to 4D are graphs showing relationships between a solubility parameter of the resin composition and the adhesive strength after leaving to stand in the high-temperature and high-humidity environment, wherein FIG. 4A shows the relationship of a SP value and the adhesive strength and FIGS. 4B to 4D respectively show the relationships of a dispersion term, a polarity term and a hydrogen bond term of a Hansen solubility parameter with the adhesive strength.

FIGS. 5A to 5D are graphs showing relationships of the solubility parameter of the resin composition and a reduction rate of the adhesive strength due to leaving to stand in the high-temperature and high-humidity environment, wherein FIG. 5A shows the relationship of the SP value and the reduction rate of the adhesive strength and FIGS. 5B to 5D respectively show the relationship of the dispersion term, the polarity term and the hydrogen bond term of the Hansen solubility parameter with the reduction rate of the adhesive strength.

### DETAILED DESCRIPTION TO EXECUTE THE INVENTION

### Description of Embodiments of Present Disclosure

First, embodiments of the present disclosure are listed and described.

The wiring harness according to the present disclosure is provided with a wire including a conductor, an insulation coating covering an outer periphery of the conductor and a conductor exposed portion, the conductor being exposed from the insulation coating in the conductor exposed portion, and a waterproof portion for integrally covering surfaces of the conductor exposed portion and the insulation coating, the insulation coating containing a plasticizer, and the waterproof portion being constituted as a cured body of a resin composition containing a urethane (meth)acrylate oligomer and a nitrogen-containing monomer, the nitrogen-containing monomer being a radical polymerizable monomer containing a nitrogen atom.

In the above wiring harness, the resin composition constituting the waterproof portion contains the nitrogen-containing monomer. Since the resin composition contains the nitrogen-containing monomer, the migration of the plasticizer from the insulation coating of the wire to the waterproof portion is suppressed even after being subjected to the high-temperature and high-humidity environment. As a result, the adhesive strength of the waterproof portion to the insulation coating containing the plasticizer is less likely to decrease even after being subjected to the high-temperature and high-humidity environment and high waterproof performance is maintained.

Here, the urethane (meth)acrylate oligomer may be a polycarbonate-based urethane (meth)acrylate oligomer. Then, an effect of suppressing a reduction in the adhesive strength of the waterproof portion under the high-temperature and high-humidity environment by the addition of the nitrogen-containing monomer becomes particularly high.

The nitrogen-containing monomer may be a (meth)acrylamide compound. By adding the (meth)acrylamide compound as the nitrogen-containing monomer to the resin composition constituting the waterproof portion, the effect of suppressing a reduction in the adhesive strength of the waterproof portion to the insulation coating after being subjected to the high-temperature and high-humidity environment by the addition of the nitrogen-containing monomer is particularly excellent.

A dispersion term of a Hansen solubility parameter of the resin composition constituting the waterproof portion may be 17.1 or more. As described later, it is clear from Examples that the addition of the nitrogen-containing monomer largely contributes to an increase of the solubility parameter, particularly the dispersion term, of the resin composition in a phenomenon in which the migration of the plasticizer from the insulation coating under the high-temperature and high-humidity environment is suppressed by the addition of the nitrogen-containing monomer to the resin composition constituting the waterproof portion. By constituting the waterproof portion using the resin composition having the dispersion term of the solubility parameter of 17.1 or more, the migration of the plasticizer from the insulation coating to the waterproof portion after being subjected to the high-temperature and high-humidity environment and a reduction in the adhesive strength of the waterproof portion caused by the plasticizer migration are particularly effectively suppressed.

The solubility parameter of the resin composition constituting the waterproof portion may be 19.5 or more. Not only the dispersion term of the Hansen solubility parameter, but also the solubility parameter of the resin composition itself has a correlation with the migration of the plasticizer under the high-temperature and high-humidity environment, and a high effect is obtained in suppressing a reduction in the adhesive strength of the waterproof portion by suppressing the migration of the plasticizer.

A content of the nitrogen-containing monomer may be 10% by mass or more in the resin composition constituting the waterproof portion. Then, the effect of suppressing the plasticizer migration to the waterproof portion by the addition of the nitrogen-containing monomer is largely demonstrated.

The wiring harness may include a plurality of the wires and a splice portion formed by joining the conductor exposed portions of the plurality of wires, and the waterproof portion may integrally cover surfaces of the splice portion and the insulation coatings. In this case, the waterproof portion maintains high adhesiveness to the insulation coatings of the wires even after being subjected to the high-temperature and high-humidity environment, whereby high waterproofness is maintained in the splice portion.

### Details of Embodiment of Present Disclosure

Hereinafter, a wiring harness according to an embodiment of the present disclosure is described with reference to the drawings. In this specification, numerical values representing various characteristics are values obtained at room temperature in the atmosphere unless otherwise specified. Further, that a certain component is a main component in a certain material indicates that that component takes up 50% by mass or more of the entire material. In this specification, “(meth)acrylate” means acrylate and methacrylate.

<Summary of Wiring Harness>

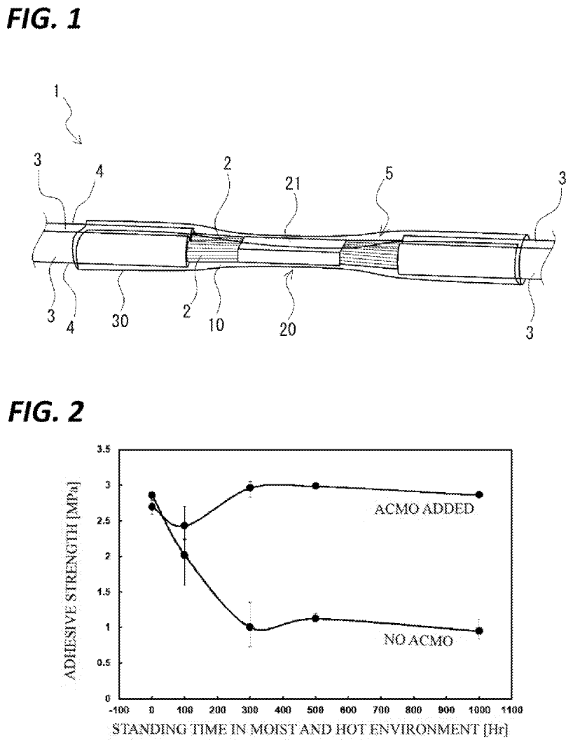

First, a summary of the wiring harness according to one embodiment of the present disclosure is described. A wiring harness 1 according to the one embodiment of the present disclosure is schematically shown in FIG. 1. A structure similar to those disclosed in Patent Document 1 to 3 can be adopted as the structure of the wiring harness 1.

The wiring harness 1 includes a plurality of wires 4. Each wire 4 includes a conductor 2 and an insulation coating 3 covering the outer periphery of the conductor 2. The wiring harness 1 includes an intermediate splice portion 20 in an intermediate part in a longitudinal direction. In each wire 4, the insulation coating 3 is removed to form a conductor exposed portion 5 in which the conductor 2 is exposed from the insulation coating 3. The respective wires 4 are joined by a crimping terminal 21 at the conductor exposed portions 5, thereby forming the intermediate splice portion 20.

In the wiring harness 1, the intermediate splice portion 20 is covered around by a waterproof portion 10. Further, the waterproof portion 10 is covered around by a protection sheet 30, thereby forming a waterproof structure. The waterproof portion 10 integrally covers the surface of the intermediate splice portion 20, in which the conductor exposed portions 5 are joined, and the surfaces of the insulation coatings 3 in regions adjacent to the conductor exposed portions 5 in a bundle of the plurality of (two in FIG. 1) wires 4. Waterproofness is provided by covering the conductor exposed portions 5 by the waterproof portion 10. That is, the conductor exposed portions 5 are sealed from an external environment by the waterproof portion 10, thereby suppressing the intrusion of electrolytes such as water into the conductor exposed portions 5 from outside.

Materials constituting the respective parts of the wiring harness 1 are briefly described. The conductor 2 constituting the wire 4 is preferably made of a metal material such as copper, copper alloy, aluminum or aluminum alloy although the material is not particularly limited.

The insulation coating 3 constituting the wire 4 is made of an insulating material containing a polymer material as a main component, and contains a plasticizer. The type of the polymer material is not particularly limited, but polyvinyl chloride (PVC) can be cited as the polymer material added with a plasticizer and often used in wire coatings. The type of the plasticizer is also not particularly limited, and examples of the plasticizer include phthalic ester-based plasticizers such as diisononyl phthalate (DINP), trimellitate ester-based plasticizers such as tris (2-ethylhexyl) trimellitate (TOTM), aliphatic dibasic acid ester-based plasticizers such as 2-ethylhexyl adipate and dibutyl sebacate, epoxy-based plasticizers such as epoxidized soybean oil, and phosphate ester-based plasticizers such as tricresyl phosphate. DINP and TOTM are plasticizers generally used in wire covering materials containing PVC as a main component, and it is preferable to use DINP or TOTM also for the insulation coating 3 in this embodiment. One type of plasticizer may be used or two or more types of plasticizers may be used in combination. A content of the plasticizer in the insulation coating 3 is also not particularly limited, but contents of 25 parts by mass or more and parts by mass or less based on 100 parts by mass of the polymer component can be given as examples of contents in general insulation coatings.

The size of the wire 4 is not particularly limited. However, if the wire 4 is thick, an effect of suppressing a reduction in adhesive strength on an interface between the waterproof portion 10 and the insulation coating 3 after being subjected to a high-temperature and high-humidity environment increases by the selection of the constituent material of the waterproof portion 10 as described later. For example, a cross-sectional area of each wire 4 is preferably 2 mm 2 or more.

The waterproof portion 10 is constituted as a cured body of a resin composition having curability. Although described in detail later, the resin composition contains a urethane (meth)acrylate oligomer and a radical polymerizable monomer containing a nitrogen atom. The resin composition preferably has at least one of photocurability and heat curability, desirably photocurability.

A material constituting the protection sheet 30 is also not particularly limited as long as being an insulating polymer material. If the resin composition constituting the waterproof portion 10 is photocurable, the protection sheet 30 preferably transmits at least part of irradiation light in photocuring the resin composition constituting the waterproof portion 10. Specifically, wrap sheets of polyolefin-based resins such as polyethylene, polypropylene, polyvinyl chloride, polyvinylidene chloride and polyvinylidene fluoride or wrap sheets of general-purpose resins such as polyester, polyethylene terephthalate and nylon can be used as the protection sheet 30. Particularly, a sheet of polyvinyl chloride resin, polyvinylidene chloride resin or polyvinylidene fluoride resin having good self-adhesion is preferably used as the protection sheet 30. Alternatively, an adhesive layer or pressure-sensitive adhesive layer may be provided on the inner surface of the protection sheet 30.

The wiring harness 1 according to this embodiment can be manufactured by a method similar to those disclosed in Patent Document 1 to 3. For example, the plurality of wires 4 are first joined at the conductor exposed portions 5, thereby preparing a wire bundle formed with the intermediate splice portion 20. Then, the intermediate splice portion 20 of that wire bundle is placed, together with parts on both sides covered by the insulation coatings 3, on the protection sheet 30. Subsequently, the resin composition, which will become the waterproof portion 10, is supplied onto the intermediate splice portion 20. At this time, the wire bundle may be placed on the resin composition after the resin composition is supplied to the protection sheet 30. Alternatively, after part of the resin composition is supplied to the protection sheet 30 and that resin composition is cured by light irradiation or the like, the remaining resin composition may be supplied and the intermediate splice portion 20 may be placed.

Subsequently, such as by bending or winding the protection sheet 30, a state is formed in which the outer peripheries of the intermediate splice portion 20 and the parts covered by the insulation coatings 3 on the both sides of the intermediate splice portion 20 are covered by the resin composition and the protection sheet 30 is arranged on the outer periphery of the resin composition. The resin composition is cured by light irradiation and heating from outside the protection sheet 30.

In the embodiment described above, the wiring harness 1 includes the intermediate splice portion 20, and the waterproof portion 10 is formed in the region including the intermediate splice portion 20. However, the wiring harness according to the embodiment of the present disclosure is not limited to such a form as long as the waterproof portion is formed which integrally covers the surfaces of the conductor exposed portions, in which the conductors are exposed from the insulation coatings, and the insulation coatings in the regions adjacent to the conductor exposed portions. For example, if conductor exposed portions of a plurality of wires constituting a wire bundle are joined to form an end splice portion in an end part of a wiring harness, a waterproof portion can be provided by covering that end splice portion. Further, a waterproof portion may be provided by covering a conductor exposed portion, in which a conductor is exposed from an insulation coating, in a single wire without being limited to a splice portion joining conductor exposed portions of a plurality of wires. For example, in such a form that a connection terminal is connected to a conductor exposed portion provided on an end of one wire, a waterproof portion may be provided on a boundary part between the connection terminal and the wire. Alternatively, a conductor exposed portion may be provided in an intermediate part of one wire and a waterproof portion may be provided in a region including that conductor exposed portion.

<Constituent Material of Waterproof Portion>

Next, a constituent material of the waterproof portion 10 provided in the wiring harness 1 is described. The waterproof portion 10 is constituted as a cured body of the resin composition having curability.

The resin composition constituting the waterproof portion 10 contains a urethane (meth)acrylate oligomer and a nitrogen-containing monomer. By adding the nitrogen-containing monomer to the resin composition, a phenomenon in which the plasticizer migrates from the insulation coatings 3 to the waterproof portion 10 and the adhesiveness of the waterproof portion 10 to the insulation coatings 3 is reduced is suppressed when the wiring harness 1 is placed in a high-temperature and high-humidity environment.

The urethane (meth)acrylate oligomer is a compound in which hydroxy (meth)acrylate is bonded to an end of an oligomer obtained by polymerizing an isocyanate compound and a polyol compound. Since a cured body of the urethane (meth)acrylate oligomer is excellent in adhesiveness and exhibits high waterproofness and is also excellent in flexibility, the urethane (meth)acrylate oligomer is suitably used to constitute the waterproof portion 10.

Typical examples of the urethane (meth)acrylate oligomer are polyester-based urethane (meth)acrylate oligomers having a polyester skeleton in a site originated from a polyol compound and polyether-based urethane (meth)acrylate oligomers having a polyether structure in a site originated from a polyol compound. In this embodiment, either one of those types may be used as the urethane (meth)acrylate oligomer, but the use of a polyester-based urethane (meth)acrylate oligomer, particularly a polycarbonate-based urethane (meth)acrylate oligomer, is preferable. As described in later Examples, by using a polyester-based urethane (meth)acrylate oligomer, particularly, a polycarbonate-based urethane (meth)acrylate oligomer, an effect of suppressing the migration of the plasticizer under a high-temperature and high-humidity environment and a reduction in adhesiveness by the addition of the nitrogen-containing monomer is obtained particularly high. One type of urethane (meth)acrylate oligomer may be used or two or more types of urethane (meth)acrylate oligomers may be used in combination. Oligomers include those called pre-polymers.

The nitrogen-containing monomer to be added to the resin composition is a radical polymerizable monomer containing a nitrogen atom. The radical polymerizable monomer is a monomer capable of radical polymerization by light and heat, and examples thereof include molecules containing an ethylenic double bond in the form of a (meth)acryloyl group or (meth)acrylamide group. A specific type of the nitrogen-containing monomer is not particularly limited, but it is preferable to use a (meth)acrylamide compound or compound containing a nitrogen atom in a ring structure in terms of a high effect of suppressing the migration of the plasticizer, high curability, easy availability and the like. Only type of nitrogen-containing monomer may be used or two or more types of nitrogen-containing monomers may be used in combination.

The (meth)acrylamide compound is a compound including an acrylamide group or methacrylamide group and has a structure of the following Formula 1.

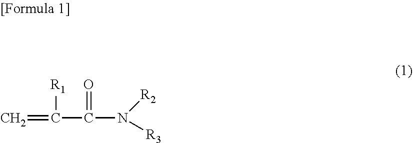

In Formula 1, R₁ is a hydrogen atom or methyl group. R₂ and R₃ are not particularly limited, but each may be independently a hydrogen atom or hydrocarbon group. This form also includes a case where R₂ and R₃ are bonded to each other by a ring structure and also includes a case where a ring structure skeleton includes an oxygen atom besides a case where the ring structure skeleton is composed only of carbon atoms. Carbon numbers of R₂ and R₃ are not particularly limited, but each is preferably 1 or more and 18 or less.

The following molecules can be illustrated as the (meth)acrylamide compound applicable as the nitrogen-containing monomer.

4-acryloyl morpholine (ACMO)

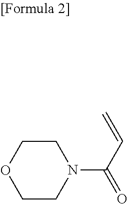

N, N-dimethylacrylamide (DMAA)

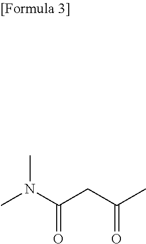

A compound in which a ring structure containing a nitrogen atom and an ethylenic unsaturated bond coexist in one molecule can be illustrated as a compound applicable as the nitrogen-containing monomer and containing a nitrogen atom in a ring structure. The ring structure is preferably a saturated ring structure. Further, a carbon atom constituting the ethylenic unsaturated bond is preferably bonded to the nitrogen atom constituting the ring structure. Caprolactam rings, pyrrolidone rings, morpholine rings, isocyanuric acid skeletons can be illustrated as the saturated ring structure containing the nitrogen atom. Including the caprolactam ring or morpholine ring, out of these ring structures, is particularly preferable in terms of a high effect of suppressing the migration of the plasticizer and the like.

The following molecules can be illustrated as a compound applicable as a nitrogen-containing monomer and containing a nitrogen atom in a ring structure. Note that 4-acryloyl morpholine mentioned above is acrylamide expressed by Formula 1 and also a compound containing a nitrogen atom in a ring structure.

N-vinyl-ε-caprolactam (NVC)

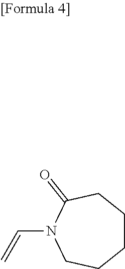

N-vinyl-2-pyrrolidone (NVP)

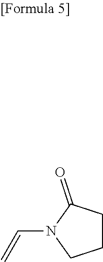

Isocyanuric acid tris(2-acryloyloxyethyl)

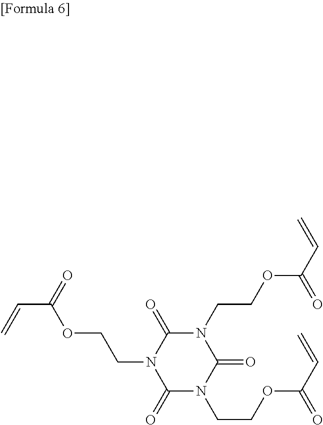 [SMILES: C=CC(=O)OCCn1c(=O)n(CCOC(=O)C=C)c(=O)n(CCOC(=O)C=C)c1=O]

In the resin composition constituting the waterproof portion 10, a content of the nitrogen-containing monomer is not particularly limited, but is preferably 10% by mass or more, further 25% by mass or more of the entire resin composition in terms of enhancing the migration of the plasticizer after being subjected to a high-temperature and high-humidity environment and the effect of suppressing a reduction in adhesive strength and the like. On the other hand, the content of the nitrogen-containing monomer may be 85% by mass or less in terms of ensuring a sufficient content of the urethane (meth)acrylate oligomer and the like.

The resin composition constituting the waterproof portion 10 preferably contains a photopolymerization initiator or thermal polymerization initiator as a radical polymerization initiator in addition to the urethane (meth)acrylate oligomer and the nitrogen-containing monomer. The resin composition may appropriately contain components other than the urethane (meth)acrylate oligomer and the nitrogen-containing monomer besides the radical polymerization initiator as long as characteristics exhibited by the urethane (meth)acrylate oligomer and the nitrogen-containing monomer such as waterproofness and the suppression of the plasticizer migration are not significantly impaired. (Meth)acrylate oligomers other than the urethane (meth)acrylate oligomer can be cited as such components. Further, radical polymerizable monomers other than the nitrogen-containing monomer, including (meth)acrylate monomers, such as those used as a reactive diluent can be cited as such components. Further, the resin composition may appropriately contain additives such as a stabilizer, a plasticizer, a softener, a pigment, a dye, an antistatic agent, a flame retardant, an adhesion imparting agent, a sensitizer, a dispersant, a solvent and an antibacterial and antifungal agent. Note that, if the resin composition contains the plasticizer, a content (mass ratio to the entire material) thereof may be set less than that of the plasticizer in the insulation coatings 3.

In the wiring harness 1 according to this embodiment, the waterproof portion 10 integrally covers the surfaces of the intermediate splice portion 20, in which the conductor exposed portions 5 are joined, and the insulation coatings 3 of the wires 4 constituting the wire bundle, and the waterproof portion 10 is in contact with the surfaces of the insulation coatings 3. If a part of the wiring harness 1 including the waterproof portion 10 is placed in a high-temperature and high-humidity environment in this state, there is a possibility that the plasticizer contained in the insulation coatings 3 migrates to the waterproof portion 10. If the migration of the plasticizer occurs, the constituent materials of the insulation coatings 3 and the waterproof portion 10 are altered and there is a possibility that the adhesive strength of the waterproof portion 10 is reduced on the interfaces between the waterproof portion 10 and the insulation coatings 3. For example, if the plasticizer contained in the insulation coatings 3 is reduced due to the migration of the plasticizer after being subjected to the high-temperature and high-humidity environment, the insulation coatings 3 contract when the temperature returns to normal temperature, whereby a thermal stress is generated on the interfaces with the waterproof portion 10 and the adhesive strength on the interfaces with the waterproof portion 10 is reduced. If the adhesive strength is reduced on the interfaces between the waterproof portion 10 and the insulation coatings 3 in this way, it may not be possible to sufficiently suppress the intrusion of water from the interfaces. Actually, if the waterproof portion 10 is made of a resin composition containing no nitrogen-containing monomer as described in Examples later, the adhesive strength is reduced by the migration of the plasticizer in the high-temperature and high-humidity environment.

In contrast, by adding the nitrogen-containing monomer to the resin composition constituting the waterproof portion 10, the plasticizer is less likely to migrate from the insulation coatings 3 to the waterproof portion 10 even if the part including the waterproof portion 10 in the wiring harness 1 is placed in the high-temperature and high-humidity environment. As a result, even after being subjected to the high-temperature and high-humidity environment, high adhesiveness of the waterproof portion 10 to the insulation coatings 3 can be maintained and a state where high waterproofness is exhibited can be maintained. For example, in the case of using the wiring harness 1 in an automotive vehicle, a situation where the waterproof portion is exposed to a high-temperature and high-humidity environment is assumed and it is important to be able to maintain high waterproofness even after being subjected to the high-temperature and high-humidity environment.

The adhesive strength between the waterproof portion 10 and the insulation coating 3 can be evaluated by observing a failure form and measuring the adhesive strength by conducting a shear adhesion test for model samples in which an adhesive portion is formed between respective constituent materials. For example, the shear adhesion test may be conducted in accordance with JIS K6850 after the adhesive portion is left to stand in a moist and hot environment having a temperature of 85° C. and a humidity of 85% RH for 250 hours. At this time, if the failure form is not an interface failure, but a cohesive failure of the constituent material of the waterproof portion 10 or if the insulation coating 3 is broken or elongated before the cohesive failure, it can be said that a sufficiently high adhesive strength is obtained even after being subjected to the moist and hot environment. A form in which the break or elongation of the insulation coating 3 occurs is particularly preferable. Further, the adhesive strength of the adhesive portion after being left to stand in the moist and hot environment for 250 hours is preferably 1.5 MPa or more, further 2.0 MPa or more.

<Migration of Plasticizer to Waterproof Portion and Solubility Parameter>

As described above, by adding the nitrogen-containing monomer to the resin composition constituting the waterproof portion 10, the migration of the plasticizer from the insulation coatings 3 to the waterproof portion 10 can be suppressed even under the high-temperature and high-humidity environment. As shown in Examples later, this suppression of the plasticizer migration can be associated with an increase of a solubility parameter by the addition of the nitrogen-containing monomer to the resin composition. As solubility parameters of two substances are more separated, a compatibility phenomenon is less likely to occur between those substances. Thus, as the solubility parameter of the waterproof portion 10 and the solubility parameter of the plasticizer contained in the insulation coatings 3 are more separated, the plasticizer is less likely to migrate to the waterproof portion 10. The plasticizer is a substance having a relatively low solubility parameter. By adding the nitrogen-containing monomer to the resin composition constituting the waterproof portion 10, the solubility parameter of the waterproof portion 10 increases and is separated to be even higher than the solubility parameter of the plasticizer. In this way, the migration of the plasticizer is thought to be suppressed. In the resin composition constituting the waterproof portion 10, as the solubility parameter and the value of each of terms δ_{D}, δ_{P}, and δ_{H} to be described later increase, the solubility parameter and the value of each term of the waterproof portion 10 constituted as a cured body of the resin composition also increase.

A contribution of the solubility parameter can be separated according to the type of an intermolecular interaction as in Equation (2) below.

δP²=δ_{D}²+δ_{P}²+δ_{H}² (2)

Here, δ_{D}, δ_{P}, and δ_{H} are respectively a dispersion term, a polarity term and a hydrogen bond term of a Hansen solubility parameter. The dispersion term S D represents a contribution of the intermolecular interaction by a dispersion force such as a van der waals force, the polarity term Sp represents a contribution of the intermolecular interaction by molecular polarity such as dipolar interaction and the hydrogen bond term δ_{H} represents a contribution of the intermolecular interaction by hydrogen bond. SP in Equation 2 is a total solubility parameter and corresponds to a Hildebrand solubility parameter (SP value).

In this embodiment, the contribution of the dispersion term, out of the solubility parameter, is thought to be particularly large in a phenomenon in which the plasticizer migration and a reduction in adhesive strength in the high-temperature and high-humidity environment are suppressed by the addition of the nitrogen-containing monomer to the waterproof portion 10. As shown in Examples, the suppression of the adhesive strength reduction shows a clear correlation with the dispersion term of the solubility parameter, but does not show a clear correlation with the polarity term and the hydrogen bond term. By the addition of the nitrogen-containing monomer, the dispersion term of the solubility parameter of the resin composition constituting the waterproof portion 10 increases and becomes even larger than the dispersion term of the plasticizer, whereby the migration of the plasticizer to the waterproof portion 10 is thought to be suppressed.

As more nitrogen-containing monomer is added to the resin composition constituting the waterproof portion 10, the solubility parameter, particularly the dispersion term, of the resin composition increases. If the dispersion term of the solubility parameter of the resin composition is set to 17.1 or more, further 17.3 or more or 17.5 or more by selecting the type and amount of the nitrogen-containing monomer, a large effect is obtained in suppressing the migration of the plasticizer to the waterproof portion 10 in the high-temperature and high-humidity environment and suppressing a reduction in the adhesive strength caused by the plasticizer migration. The SP value may be set to 19.5 or more, further 20.5 or more.

If the entire resin composition constituting the waterproof portion 10 can provide a solubility parameter large enough to sufficiently suppress the migration of the plasticizer, the solubility parameter of the nitrogen-containing monomer itself is not particularly limited. However, as the nitrogen-containing monomer itself has a larger solubility parameter, there is a higher effect of increasing the solubility parameter of the resin composition. For example, the nitrogen-containing monomer may have a solubility parameter having a dispersion term of 17.0 or more, further 17.5 or more or 18.0 or more and a SP value of 19.0 or more, 21.0 or more or 22.0 or more.

As described above, the type of the plasticizer to be contained in the insulation coatings 3 is not particularly limited. However, in terms of relatively enhancing the effect of suppressing the plasticizer migration obtained by the addition of the nitrogen-containing monomer to the waterproof portion 10 as compared to the case where the nitrogen-containing monomer is not added, the plasticizer itself preferably has such a solubility parameter that the migration to the waterproof portion 10 not added with the nitrogen-containing monomer easily occurs, i.e. a certain small solubility parameter. For example, DINP has a solubility parameter having a dispersion term of 16.3 and a SP value of 17.2. TOTM has a dispersion term of 16.8 and a SP value of 17.7.

### EXAMPLES

Examples are described below. Here, an effect brought about by adding a nitrogen-containing monomer to a resin composition constituting a waterproof portion was confirmed and relationships with a solubility parameter of the resin composition constituting the waterproof portion were verified. Samples were prepared and evaluated at room temperature in the atmosphere below unless otherwise specified. Note that the present invention is not limited to these Examples.

[1] Change in Adhesiveness by Addition of Nitrogen-Containing Monomer

First, it was confirmed how adhesiveness on an interface with an insulating coating material changes after being subjected to a high-temperature and high-humidity environment for a resin composition obtained by adding a polymerizable monomer to a urethane acrylate oligomer.

[Test 1-1] Influence on Adhesiveness by Resin Composition

<Preparation of Samples>

As shown in Table 1, resin compositions serving as the samples were prepared by compounding and uniformly mixing a urethane acrylate oligomer and a nitrogen-containing monomer or polymerizable monomer containing no nitrogen. In each sample, a compounded amount of the monomer was 50% by mass of the entire resin composition.

Materials used in preparing the resin compositions are as follows.

(Urethane Acrylate Oligomer)
Polycarbonate-based urethane acrylate oligomer
Polyether-based urethane acrylate oligomer

(Nitrogen-Containing Monomer)
ACMO: 4-acryloyl morpholine
DMAA: N, N-dimethylacrylamide
NVC: N-vinyl-ε-caprolactam
MN1: isocyanuric acid tris(2-acryloyloxyethyl)

(Nitrogen-Noncontaining Monomer)
IBXA: isobornyl acrylate
BCHA: tert-butylcyclohexanol acrylate
HPA: hydroxypropyl acrylate
MN2: tricyclodecanedimethanol diacrylate
MN3: 3, 3, 5-trimethylcyclohexyl acrylate

<Evaluation of Adhesive Strength>

Adhesive strength between a PVC coating material and a cured body of the resin composition prepared above was measured as a model of an adhesive portion between a waterproof portion of a wiring harness and an insulation coating. Specifically, the resin composition arranged between surfaces of two PVC coating materials (thickness of 0.4 mm) and having a resin material cured by ultraviolet irradiation was prepared as a test piece for adhesive strength measurement. By conducting a shear adhesion test for this test piece in accordance with JIS K6850, tensile shear adhesive strength was measured and a failure form was observed. This evaluation result was set as a result of the shear adhesion test in an initial state. The PCV coating materials containing DINP or TOTM as a plasticizer were used.

Further, the same test piece as above was left to stand in a moist and hot environment having a temperature of 85° and a humidity of 85% RH for 250 hours. After the test piece was allowed to cool to room temperature, the shear adhesion test was conducted in a manner similar to the above. This evaluation result was set as a result of the shear adhesion test after humidifying and heating.

<Evaluation Result>

The adhesion strengths and the failure forms obtained in the initial state and after being humidified and heated by the shear adhesion test are shown, together with the types of the materials used in preparing the resin compositions and the types of the plasticizers added to the coating materials, for Samples A1 to A15 in Table 1 below. As described above, a content of the monomer in the resin composition is 50% by mass in any of the samples. Note that “Interface” represents an interface failure and “Cohesive” represents a cohesive failure in the cured body of the resin composition for the failure forms. “Coating Break” and “Coating Elg.” represent a phenomenon in which the coating material is broken or elongated before the interface failure or cohesive failure occurs. A value displayed as the “adhesive strength” represents shear strength when the coating break or coating elongation occurs, and the adhesive strength on the sample interface is larger than the displayed value.

TABLE 1

| | | | | | Shear Adhesion Test | | | |
|---|---|---|---|---|---|---|---|---|
| | Urethane | Monomer (50% by Mass) | | | Initial State | | After Humidifying and Heating | |
| Sample | Acrylate | Nitrogen- | Nitrogen- | | Adhesive | Failure | Adhesive | Failure |
| Number | Oligomer | Containing | Noncontaining | Plasticizer | Strength [MPa] | Form | Strength [MPa] | Form |
| A1 | Polycarbonate- | ACMO | — | DINP | 2.3 | Coating Break | 3.1 | Coating Break |
| A2 | based | DMAA | — | DINP | 2.4 | Coating Break | 2.6 | Coating Break |
| A3 | | NVC | — | DINP | 2.6 | Coating Break | 3.2 | Coating Break |
| A4 | | MN1 | — | DINP | 2.3 | Coating Break | 2.9 | Interface |
| A5 | | — | IBXA | DINP | 2.1 | Coating Break | 2.8 | Interface |
| A6 | | — | BCHA | DINP | 2.4 | Interface | 1.2 | Interface |
| A7 | | — | HPA | DINP | 1.6 | Interface | 1.3 | Interface |
| A8 | Polyether-based | ACMO | — | DINP | 2.8 | Interface | 0.7 | Interface |
| A9 | | DMAA | — | DINP | 2.8 | Interface | 0.7 | Interface |
| A10 | | NVC | — | DINP | 2.5 | Interface | 0.6 | Interface |
| A11 | | — | IBXA | DINP | 1.2 | Interface | 0.1 | Interface |
| A12 | | — | BCHA | DINP | 0.6 | Interface | 0.3 | Interface |
| A13 | | — | MN2 | DINP | 0.9 | Interface | 0.2 | Interface |
| A14 | | — | MN3 | DINP | 0.4 | Interface | 0.1 | Interface |
| A15 | Polycarbonate- | ACMO | — | TOTM | 2.0 | Coating Break | 2.3 | Coating Break |
| | based | | | | | | | |

According to Table 1, in the case of using the polycarbonate-based urethane acrylate oligomer, the interface failure occurred in any of the shear adhesion tests after humidifying and heating in Samples A5 to A7 added with the nitrogen-noncontaining monomer. Further, in Samples A6 and A7, the adhesive strength after humidifying and heating is clearly reduced as compared to the initial stage, and the value of the adhesive strength after humidifying and heating is as small as 1.3 MPa or less. In contrast, in any of Samples A1 to A4 added with the nitrogen-containing monomer, the adhesive strength measured after humidifying and heating is higher than that measured in the initial state and indicates a value equal to or larger than 2.6 MPa. Particularly, in Samples A1 to A3, the failure form after humidifying and heating is the coating break and the interface failure does not occur. Note that, as described above, actual adhesive strength on the sample interface is supposed to be larger than the measured adhesive strength when the coating elongation or coating break is observed, and an increase amount of the adhesive strength measured after humidifying and heating from the adhesive strength measured in the initial state does not necessarily mean an increase amount of the adhesive strength on the interface. Also in the case of using the polyether-based urethane acrylate oligomer, if Samples A8 to A10 added with the nitrogen-containing monomer and Samples A11 to A14 added with the nitrogen-noncontaining monomer are compared, the failure form after humidifying and heating is the interface failure in any of the samples. However, the adhesive strength after humidifying and heating is 0.3 MPa or less in Samples A11 to A14 added with the nitrogen-noncontaining monomer, whereas the adhesive strength after humidifying and heating is as large as 0.6 MPa or more in Samples A8 to A10 added with the nitrogen-containing monomer.

From these results, both when the polycarbonate-based urethane acrylate oligomer is used and when the polyether-based urethane acrylate oligomer is used, adhesiveness after humidifying and heating on the interface between the cured body and the coating material can be said to be higher in the case of adding the nitrogen-containing monomer to those oligomers than in the case of adding the nitrogen-noncontaining monomer. That is, the addition of the nitrogen-containing monomer to the urethane acrylate oligomer is understood to indicate an effect of suppressing a reduction in adhesiveness in a moist and hot environment.

If the magnitude of the effect in suppressing a reduction in adhesiveness in the moist and hot environment is compared by the type of the urethane acrylate oligomer, the value of the adhesive strength after humidifying and heating is larger in the case of the polycarbonate-based urethane acrylate oligomer than in the case of the polyether-based urethane acrylate oligomer. Further, in the case of the polyether-based urethane acrylate oligomer, the adhesive strength is reduced after leaving to stand in the moist and hot environment although a reduction width is suppressed to be small by the addition of the nitrogen-containing monomer. On the other hand, in the case of the polycarbonate-based urethane acrylate oligomer, the adhesive strength is not reduced after leaving to stand in the moist and hot environment and the failure form is possibly the coating break. As just described, the effect of suppressing a reduction in adhesiveness in the moist and hot environment by the addition of the nitrogen-containing monomer is particularly large in the case of the polycarbonate-based urethane acrylate oligomer.

Samples A1 to A4 are different from each other in the type of the nitrogen-containing monomer added to the resin composition. Out of these, the failure form after humidifying and heating is the interface failure in Sample A4, whereas the failure form is the coating break in Samples A1 to A3. From this, samples A1 to A3 can be said to have higher adhesive strength on the interface after humidifying and heating than Sample A4. That is, the effect of suppressing a reduction in adhesive strength by leaving to stand in the moist and hot environment can be said to be particularly large by using a (meth)acrylamide compound having the structure of Formula 1 as in Samples A1 and A2 or using the nitrogen-containing monomer containing a nitrogen atom in a caprolactam ring as in Sample A3, out of the nitrogen-containing monomers.

Samples A1 and A15 are different in the type of the plasticizer contained in the coating material. However, in both samples, the coating break is observed as the failure form in the shear adhesion test after humidifying and heating and a reduction in adhesive strength is not seen. As shown in later test [2], a reduction in adhesive strength after being subjected to the moist and hot environment is thought to result from the migration of the plasticizer from the coating material to the cured body of the resin composition, but the effect of suppressing a reduction in adhesiveness by the moist and hot environment is understood to be obtained by the addition of the nitrogen-containing monomer to the resin composition without depending on the type of the plasticizer to be added to the coating material.

[Test 1-2] Change over Time in Moist and Hot Environment

<Preparation of Samples>

Resin compositions were prepared by adding ACMO to a polycarbonate-based urethane acrylate oligomer such that a content of ACMO is 20% by mass of a total. Further, the polycarbonate-based urethane acrylate oligomer itself was also prepared as a resin composition not added with ACMO for comparison.

<Evaluation of Adhesive Strength>

As in the above test 1-1, adhesion strength between a PCV coating material and a cured body of a resin composition was measured in an initial state and a state allowed to cool to room temperature after being left to stand in a moist and hot environment having a temperature of 85° C. and a humidity of 85% RH for a predetermined time. Four standing times of 100 hours, 300 hours, 500 hours and 1000 hours in the moist and hot environment were set. The PVC coating material containing DINP as a plasticizer was used.

<Evaluation Result>

FIG. 2 shows changes of the adhesive strength by leaving to stand in the moist and hot environment for a case where ACMO was added to the resin composition and a case where ACMO was not added. A horizontal axis represents a standing time in the moist and hot environment and a vertical axis represents measured adhesive strength. Error bars in FIG. 2 show variations of an evaluation result for a plurality of individual samples.

According to FIG. 2, the adhesive strength is almost the same regardless of the presence or absence of ACMO in the initial state (0 time). However, if the resin composition is placed in the moist and hot environment, the adhesive strength suddenly decreases during the standing period in the moist and hot environment up to about 300 hours if the resin composition contains no ACMO (no ACMO in FIG. 2), whereas a reduction in the adhesive strength converges at about 100 hours and that reduction amount is notably small if the resin composition contains ACMO (ACMO added in FIG. 2). Thereafter, the adhesive strength conversely increases, and a state where the measured value of the adhesive strength is considerably higher than that in the case of not adding ACMO is stably maintained even after 1000 hours are reached.

By adding ACMO, which is the nitrogen-containing monomer, to the urethane acrylate oligomer, an effect of suppressing a reduction in adhesive strength on the interface with the coating material in the moist and hot environment prominently appears from a region of a relatively short time such as 100 hours or less. That effect is stably maintained even if the resin composition is left to stand in the moist and hot environment for a long time such as 1000 hours. Further, although the standing time in the moist and hot environment is 250 hours in the above test 1-1, a reduction in adhesive strength already converges at 250 hours in the sample added with ACMO according to FIG. 2, and the effect of suppressing a reduction in adhesive strength after humidifying and heating by the addition of the nitrogen-containing monomer observed in the above test 1-1 is thought to be sustained even if the standing time in the moist and hot environment becomes even longer.

[2] Behavioral Changes of Plasticizer by Addition of Nitrogen-Containing Monomer

Next, it was verified how the plasticizer in the coating material behaved on the interface between the cured body and the coating material after being subjected to a high-temperature and high-humidity environment.

<Preparation of Samples>

Using the same polycarbonate-based urethane acrylate oligomer used in the test 1-1 as the urethane acrylate oligomer and ACMO as the nitrogen-containing monomer, resin compositions were prepared. The prepared resin compositions include those in which ACMO is not added to the urethane acrylate oligomer and those in which ACMO is added such that a content of ACMO is 20% by mass of a total.

<Evaluation of Migration of Plasticizer>

As in the above tests 1, samples were prepared by arranging the resin composition between surfaces of two PVC coating materials and curing a resin material by ultraviolet irradiation. The PCV coating materials containing DINP as a plasticizer were used. These samples are left to stand in a moist and hot environment having a temperature of 85° C. and a humidity of 85% RH for 250 hours. Then, a shear adhesion test was conducted for an initial state before the resin composition was left to stand in the moist and hot environment and a state after humidifying and heating by being left to stand in the moist and hot environment. Further, an infrared absorption spectroscopy measurement (ART-IR measurement) was conducted by a total reflection measurement method for parts of the cured bodies of the samples after the shear adhesion test. An infrared absorption spectroscopy measurement was conducted also for the plasticizer DINP itself for reference.

<Evaluation Result>

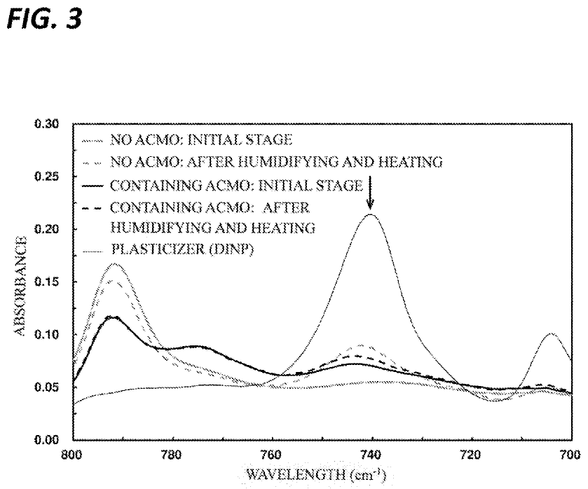

FIG. 3 shows infrared absorption spectra in the initial state and after humidifying and heating in a range of 800 to 700 cm⁻¹ for a case where ACMC was added to the urethane acrylate oligomer and a case where ACMO was not added. A spectrum (thin solid line) of the plasticizer itself is also shown in FIG. 3. In FIG. 3, as indicated by an arrow, DINP has a clear peak at 740 cm⁻¹. If a peak growth at this wavelength is seen after leaving to stand in the moist and hot environment in the spectrum of the cured body of the resin composition, it can be determined that the plasticizer migrated from the coating material to the cured body.

First, when the spectrum in the case of containing no ACMO in the urethane acrylate oligomer is seen, no peak is seen near 740 cm⁻¹ in the initial state (gray solid line). However, after humidifying and heating (gray broken line), a peak structure is seen in this wavelength region. This result indicates the migration of DINP from the coating material to the cured body of the resin composition after being subjected to the moist and hot environment. On the other hand, when the spectrum in the case of containing ACMO is seen, a spectral intensity near 740 cm⁻¹ hardly changes in the initial state (black solid line) and the state after humidifying and heating (black broken line). This result indicates that the migration of DINP from the coating material to the cured body of the resin composition hardly occurred even after being left to stand in the moist and hot environment. Note that although a weak peak structure is observed near 740 cm⁻¹ from the initial state in the sample containing ACMO, this is thought to be because ACMO itself has a weak absorption peak in this region.

As described above, the plasticizer migrates from the coating material to the cured body of the urethane acrylate oligomer not added with the nitrogen-containing monomer after being subjected to the moist and hot environment, whereas the migration of the plasticizer hardly occurs even after being subjected to the moist and hot environment by adding ACMO as the nitrogen-containing monomer. If the result having become clear in the above tests [1] that a reduction in adhesive strength on the interface between the cured body and the coating material after being subjected to the moist and hot environment is suppressed by the addition of the nitrogen-containing monomer is considered together, the suppression of the migration of the plasticizer in the moist and hot environment by the addition of the nitrogen-containing monomer can be said to lead to the suppression of a reduction in adhesive strength. If the plasticizer migrates from the coating material to the cured body of the resin composition in the moist and hot environment, the coating material contracts and a thermal stress is generated on the interface with the cured body, thereby reducing the adhesive strength, when the temperature returns to room temperature thereafter. However, by suppressing the migration of the plasticizer by the addition of the nitrogen-containing monomer to the resin composition, high adhesiveness on the interface is thought to be maintained even after being subjected to the moist and hot environment.

[3] Contribution of Solubility Parameter

Finally, it was verified how the solubility parameter of the resin composition was related to a change of the adhesive strength after being subjected to the moist and hot environment.

<Preparation of Samples>

Resin compositions serving as samples were prepared by compounding and uniformly mixing respective components in compositions shown in Tables 3 to 5 below. Each urethane acrylate oligomer and each monomer used were the same as those used in the above tests [1]. Note that, for the urethane acrylate oligomer, “Polycarbonate-based oligomer 1” is the same as that used in the above test 1-1 (weight average molecular weight: 5.4×10⁴), and “Polycarbonate-based oligomer 2” is the same as that used in the above test 1-2 (weight average molecular weight: 1.2×10⁴).

Besides, the following was used as a nitrogen-noncontaining monomer functioning as a reactive diluent.

MN4: (2-methyl-2-ethyl-1,3-dioxolane-4-yl)methyl acrylate

<Evaluation of Adhesive Strength>

As in the above test 1-1, adhesion strength between a PCV coating material and a cured body of a resin composition was measured by a shear adhesion test. Measurements were made for an initial state and a state after humidifying and heating by being allowed to cool to room temperature after being left to stand in a moist and hot environment having a temperature of 85° C. and a humidity of 85% RH for 250 hours. The PVC coating material containing DINP as a plasticizer was used.

<Estimation of Solubility Parameter>

Using calculation, a solubility parameter was estimated for the resin composition of each sample. At this time, a Hildebrand solubility parameter (SP value) was obtained as the solubility parameter and, in addition, contributions of a dispersion term δ_{D}, a polarity term δ_{P} and a hydrogen bond term δ_{H} of a Hansen solubility parameter were separated as shown in Formula 2 above.

In calculating the solubility parameter of each sample, the values of the solubility parameters of respective components shown in Table 2 below are added up in accordance with volumetric ratios of the components. The values of the solubility parameters of Table 2 are the values of the solubility parameters of the respective components of Table 2 estimated using a Hansen solubility parameter in practice (HSPiP), which is a software for calculating a solubility parameter. The value of the solubility parameter of each component calculated by the HSPiP is calculated based on a value obtained from latent heat of vaporization and the like, an inter-dipole force, an intermolecular force and the like.

TABLE 2

| | | SP Value | Dispersion Term | Polarity Term | H-Bond Term |
|---|---|---|---|---|---|
| Urethane | Polycarbonate- | 22 | 17.1 | 11.7 | 7.5 |
| acrylate | based oligomer 1 | | | | |
| oligomer | Polycarbonate- | 18.9 | 17.0 | 7.2 | 4.1 |
| | based oligomer 2 | | | | |
| Nitrogen- | ACMC | 22.3 | 18.5 | 11.2 | 5.8 |
| containing | DMAA | 21.5 | 17.1 | 10.4 | 7.6 |
| monomer | NVC | 19.2 | 17.6 | 5.6 | 5.3 |
| | MN1 | 21.8 | 17.5 | 6.4 | 11.3 |
| Nitrogen- | IBXA | 17.1 | 16.7 | 2.5 | 2.7 |
| noncontaining | HPA | 22 | 16.9 | 6.9 | 12.3 |
| monomer | MN4 | 18.2 | 16.7 | 5.2 | 5.1 |

<Evaluation Result>

Tables 3 to 5 show estimated values of the SP value and each term of the Hansen solubility parameter, measured values of the adhesive strength in the initial state and after humidifying and heating and a failure form, together with a compounded amount (unit: % by mass) of each component for resin compositions compounded in variously changed ways. A reduction rate is also shown for the adhesive strength. This reduction rate is calculated as a ratio of a reduction amount of the adhesive strength from the initial state to the state after humidifying and heating to a value in the initial state, and a negative value indicates that the adhesive strength has increased after humidifying and heating as compared to the initial state. Samples A1 to A4 and A7 in Table 5 are the same as those used in the test 1-1 shown in Table 1.

TABLE 3

| Sample Number | | B1 | B2 | B3 | B4 | B5 | B6 | B7 | B8 | B9 |
|---|---|---|---|---|---|---|---|---|---|---|
| Content | ACMO | 0 | 0 | 10 | 15 | 15 | 20 | 20 | 20 | 20 |
| [% by mass] | MN4 | 30 | 20 | 40 | 50 | 15 | 80 | 75 | 70 | 65 |
| | PC-based oligomer 1 | 70 | 80 | 50 | 35 | 70 | 0 | 5 | 10 | 15 |
| Solubility | SP value | 20.9 | 21.3 | 20.5 | 20.2 | 21.5 | 19.0 | 19.2 | 19.4 | 19.6 |
| parameter | Dispersion term | 17.0 | 17.0 | 17.1 | 17.1 | 17.2 | 17.0 | 17.1 | 17.1 | 17.1 |
| | Polarity term | 9.8 | 10.4 | 9.1 | 8.4 | 10.7 | 6.3 | 6.7 | 7.0 | 7.4 |
| | H-bond term | 6.8 | 7.0 | 6.4 | 6.1 | 6.9 | 5.2 | 5.4 | 5.5 | 5.6 |
| Initial state | Adhesive strg. [MPa] | 2.0 | 2.0 | 2.2 | 2.6 | 2.8 | 1.0 | 1.9 | 2.2 | 2.6 |
| | Failure form | Interface | Interface | Interface | Coating | Coating | Interface | Interface | Coating | Coating |
| | | | | | break | break | | | Elg. | Elg. |
| After humd. | Adhesive strg. [MPa] | 1.0 | 1.3 | 1.5 | 2.3 | 2.7 | 0.5 | 1.1 | 1.4 | 2.0 |
| and heating | Failure form | Interface | Interface | Interface | Cohesive | Interface | Interface | Cohesive | Cohesive | Cohesive |

| | | | | | | | | | |
|---|---|---|---|---|---|---|---|---|---|
| Adhesive strg. reduction rate [%] | 50 | 39 | 31 | 12 | 4 | 53 | 45 | 37 | 23 |

| Sample Number | | B10 | B11 | B12 | B13 | B14 | B15 | B16 | B17 | B18 |
|---|---|---|---|---|---|---|---|---|---|---|
| Content | ACMO | 20 | 20 | 20 | 20 | 25 | 25 | 25 | 25 | 50 |
| [% by mass] | MN4 | 60 | 50 | 45 | 50 | 55 | 50 | 45 | 25 | 0 |
| | PC-based oligomer | 20 | 30 | 35 | 30 | 20 | 25 | 30 | 50 | 50 |
| Solubility | SP value | 19.8 | 20.2 | 20.4 | 20.2 | 20.0 | 20.2 | 20.4 | 21.1 | 22.1 |
| parameter | Dispersion term | 17.1 | 17.2 | 17.2 | 17.2 | 17.2 | 17.2 | 17.3 | 17.3 | 17.8 |
| | Polarity term | 7.7 | 8.4 | 8.7 | 8.4 | 8.0 | 8.3 | 8.7 | 10.0 | 11.5 |
| | H-bond term | 5.7 | 6.0 | 6.1 | 6.0 | 5.8 | 5.9 | 6.0 | 6.5 | 6.7 |
| Initial state | Adhesive strg. [MPa] | 2.6 | 2.5 | 2.7 | 2.5 | 2.6 | 2.6 | 2.7 | 2.6 | 2.3 |
| | Failure form | Coating | Coating | Coating | Coating | Coating | Coating | Coating | Coating | Coating |
| | | break | break | break | break | break | break | break | break | break |
| After humd. | Adhesive strg. [MPa] | 2.1 | 2.0 | 2.9 | 2.9 | 2.6 | 2.8 | 2.6 | 2.8 | 3.1 |
| and heating | Failure form | Cohesive | Interface | Coating | Coating | Coating | Coating | Coating | Coating | Coating |
| | | | | break | Elg. | Elg. | break | break | break | break |

| | | | | | | | | | |
|---|---|---|---|---|---|---|---|---|---|
| Adhesive strg reduction rate [%] | 20 | 18 | −9 | −19 | 3 | −7 | 4 | −6 | −37 |

TABLE 4

| Sample Number | | C1 | C2 | C3 | C4 | C5 |
|---|---|---|---|---|---|---|
| Content | ACMO | 0 | 10 | 20 | 30 | 50 |
| [% by mass] | PC-based oligomer 2 | 100 | 90 | 80 | 70 | 50 |
| Solubility | SP value | 18.9 | 19.2 | 19.5 | 19.8 | 20.5 |
| parameter | Dispersion term | 17.0 | 17.1 | 17.3 | 17.4 | 17.7 |
| | Polarity term | 7.2 | 7.6 | 7.9 | 8.3 | 9.1 |
| | H-bond term | 4.1 | 4.3 | 4.4 | 4.6 | 4.9 |
| Initial state | Adhesive strg. [MPa] | 2.9 | 2.6 | 2.6 | 2.7 | 2.2 |
| | Failure form | Coating | Coating | Coating | Coating | Coating |
| | | break | Elg. | break | break | break |
| After humd. | Adhesive strg. [MPa] | 0.72 | 1.04 | 2.13 | 3.19 | 2.45 |
| and heating | Failure form | Interface | Interface | Interface | Coating | Coating |
| | | | | | break | break |

| | | | | | |
|---|---|---|---|---|---|
| Adhesive strg reduction rate [%] | 75 | 60 | 18 | −17 | −14 |

TABLE 5

| Sample Number | | A1 | A2 | A3 | A4 | A7 |
|---|---|---|---|---|---|---|
| Monomer type | | ACMO | DMAA | NVC | MN1 | HPA |
| Content | Monomer | 50 | 50 | 50 | 50 | 50 |
| [% by mass] | PC-based oligomer 1 | 50 | 50 | 50 | 50 | 50 |
| Solubility | SP value | 22.1 | 21.8 | 20.6 | 21.9 | 22.0 |
| parameter | Dispersion term | 17.8 | 17.1 | 17.3 | 17.3 | 17.0 |
| | Polarity term | 11.5 | 11.1 | 8.7 | 9.4 | 9.4 |
| | H-bond term | 6.7 | 7.5 | 6.4 | 9.2 | 9.8 |
| Initial state | Adhesive strg. [MPa] | 2.6 | 2.4 | 2.6 | 2.3 | 1.6 |
| | Failure form | Coating break | Coating break | Coating break | Coating Elg. | Interface |
| After humd. | Adhesive strg. [MPa] | 2.9 | 2.6 | 3.2 | 2.9 | 1.3 |
| and heating | Failure form | Coating break | Coating break | Coating break | Interface | Interface |

| | | | | | |
|---|---|---|---|---|---|
| Adhesive strg reduction rate [%] | −12 | −8 | −22 | −24 | 23 |

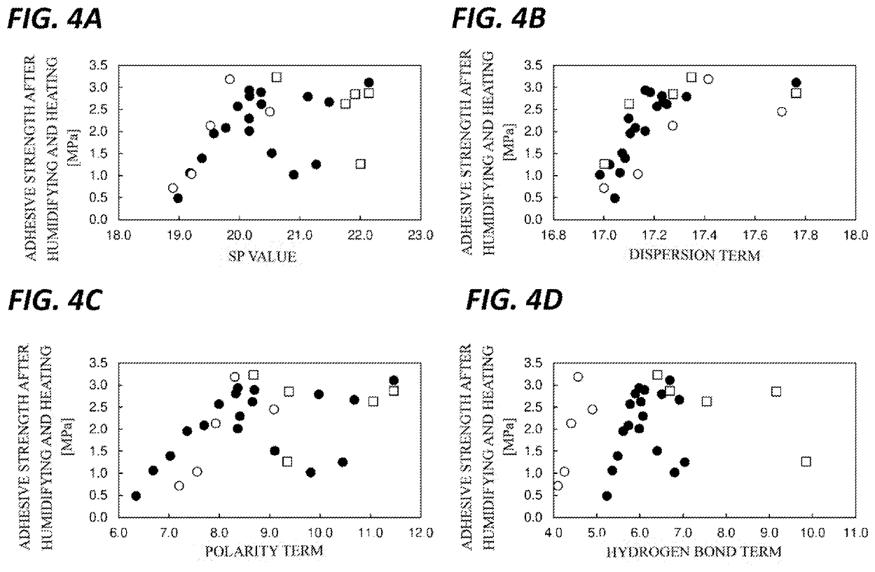

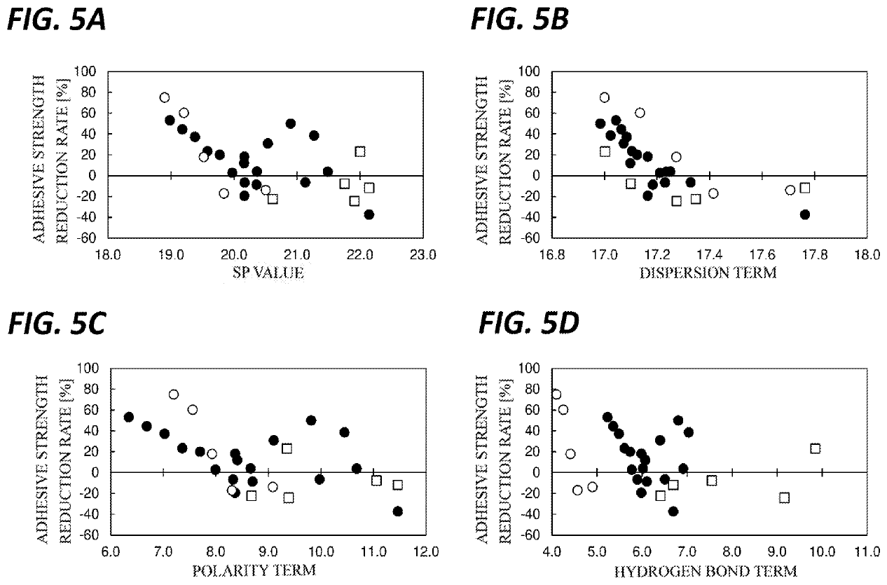

Further, relationships between the estimated values of the SP value and the dispersion term, the polarity term and the hydrogen-bond term of the Hansen solubility parameter and the measured value of the adhesive strength after humidifying and heating are shown based on the data of Tables 3 to 5 above in FIGS. 4A to 4D. Further, relationships between the estimated values of the SP value and the dispersion term, the polarity term and the hydrogen-bond term of the Hansen solubility parameter and the reduction rate of the adhesive strength caused by the moist and hot environment are shown in FIGS. 5A to 5D. In each figure, samples B1 to B18 of Table 3 using the polycarbonate-based oligomer 1, ACMO and MN4 as constituent components are represented by black circles (●). Further, samples C1 to C5 of Table 4 using the polycarbonate-based oligomer 2 and ACMO as constituent components are represented by white circles (∘). Further, samples A1 to A4 and A7 of Table 5 using the polycarbonate-based oligomer 1 and various monomers are represented by white squares (▪).

The relationships between the adhesive strength after humidifying and heating and the reduction rate of the adhesive strength (vertical axis) and the SP value (horizontal axis) shown in FIGS. 4A and 5A show tendencies to increase the adhesive strength after humidifying and heating and decrease the reduction rate of the adhesive strength as the SP value of the resin composition increases although the variance of data points is large. Further, those tendencies are generally saturated in a SP value region equal to or higher than 19.5. If this result and the above test results [1] and [2] are considered together, it can be said that the solubility parameter of the resin composition is increased by the addition of the nitrogen-containing monomer, whereby the migration of the plasticizer from the coating material to the cured body of the resin composition after being subjected to the moist and hot environment is suppressed and, further, a reduction in the adhesive strength of the interface is suppressed.

Further, the relationships between the adhesive strength after humidifying and heating and the reduction rate of the adhesive strength (vertical axis) and the dispersion term of the solubility parameter (horizontal axis) shown in FIGS. 4B and 5B show that the variance of data points is reduced and tendencies to increase the adhesive strength after humidifying and heating and decrease the reduction rate of the adhesive strength and a behavior to generally saturate those tendencies in a region equal to or higher than 17.1 become clearer as the dispersion term increases as compared to the relationships with the SP value shown in FIGS. 4A and 5A. On the other hand, if the polarity term is taken on the horizontal axis as in FIGS. 4C and 5C or if the hydrogen-bond term is taken on the horizontal axis as in FIGS. 4D and 5D, no clear correlation is seen between the adhesive strength after humidifying and heating and the reduction rate of the adhesive strength unlike the case where the dispersion term is taken on the horizontal axis as in FIGS. 4B and 5B. Rather, it can be said that the variance of data points is larger and a correlation is lower than in the case where the SP value is taken on the horizontal axis as in FIGS. 4A and 5A. Particularly, if the hydrogen-bond term is taken on the horizontal axis as in FIGS. 4D and 5D, a distribution region of the data points is separated in a horizontal axis direction due to differences in the type of components represented by plot symbols.

From these results, a phenomenon that the plasticizer migration and a reduction in adhesive strength after being subjected to the moist and hot environment are suppressed by the addition of the nitrogen-containing monomer is understood to have a high correlation mainly with the dispersion term, out of the solubility parameter of the resin composition. Further, in graphs of FIGS. 4A and 5A taking the SP value on the horizontal axis and graphs of FIGS. 4B and 5B taking the dispersion term on the horizontal axis, any of the data points plotted by different plot symbols and representing different types of components has a common tendency. This shows that the suppression of the plasticizer migration and a reduction in adhesive strength can be controlled by the solubility parameter, which is a macroscopic physical property value, particularly by the dispersion term, without considering a detailed molecular structure.

Further, results compiled in Tables 3 and 4 also show an effect of an added amount of the nitrogen-containing monomer to the resin composition. According to Tables 3 and 4, there are seen tendencies to increase the adhesive strength after humidifying and heating and decrease the reduction amount of the adhesive strength as the added amount of the nitrogen-containing monomer (ACMO) increases. Further, the failure form changes to a form indicating firm adhesion of the interface, from the interface failure to the cohesive failure and further from the coating break to the coating elongation. Generally, the tendencies to increase the adhesive strength after humidifying and heating and reduce the reduction amount of the adhesive strength start to be saturated and the failure form becomes the cohesive failure and further the coating break and the coating elongation in a region where the content of the nitrogen-containing monomer is 10% by mass or more. Those behaviors become clearer in a region where the content of the nitrogen-containing monomer is 25% by mass or more. Further, if cases where the added amount of the nitrogen-containing monomer (ACMO) is equal and the added amount of the nitrogen-noncontaining monomer (MN4) is different are compared, the adhesive strength after humidifying and heating increases and the reduction amount of the adhesive strength decreases as the added amount of the nitrogen-noncontaining monomer decreases.

Although the embodiment of the present disclosure has been described in detail above, the present invention is not limited to the above embodiment at all and various changes can be made without departing from the gist of the present invention.

### LIST OF REFERENCE NUMERALS

1 wiring harness
2 conductor
3 insulation coating
4 wire
5 conductor exposed portion
10 waterproof portion
20 intermediate splice portion
21 crimping terminal
30 protection sheet

1. A wiring harness, comprising:
a wire including a conductor, an insulation coating covering an outer periphery of the conductor, and a conductor exposed portion, the conductor being exposed from the insulation coating in the conductor exposed portion; and
a waterproof portion for integrally covering surfaces of the conductor exposed portion and the insulation coating,
the insulation coating containing a plasticizer, and
the waterproof portion being constituted as a cured body of a resin composition containing:
a urethane (meth)acrylate oligomer; and
a nitrogen-containing monomer, the nitrogen-containing monomer being a radical polymerizable monomer containing a nitrogen atom.

2. The wiring harness of claim 1, wherein the urethane (meth)acrylate oligomer is a polycarbonate-based urethane (meth)acrylate oligomer.

3. The wiring harness of claim 1, wherein the nitrogen-containing monomer is a (meth)acrylamide compound.

4. The wiring harness of claim 1, wherein a dispersion term of a Hansen solubility parameter of the resin composition constituting the waterproof portion is 17.1 or more.

5. The wiring harness of claim 1, wherein a solubility parameter of the resin composition constituting the waterproof portion is 19.5 or more.

6. The wiring harness of claim 1, wherein a content of the nitrogen-containing monomer is 10% by mass or more in the resin composition constituting the waterproof portion.

7. The wiring harness of claim 1, wherein:
the wiring harness includes a plurality of the wires and a splice portion formed by joining the conductor exposed portions of the plurality of wires, and
the waterproof portion integrally covers surfaces of the splice portion and the insulation coatings.
